(19) United States
(12) Patent Application Publication
(10) Pub. No.: US 2024/0182082 A1
(43) Pub. Date: Jun. 6, 2024

(54) POLICY PLANNING USING BEHAVIOR MODELS FOR AUTONOMOUS SYSTEMS AND APPLICATIONS

(71) Applicant: NVIDIA Corporation, Santa Clara, CA (US)

(72) Inventors: Yuxiao Chen, Newark, CA (US); Peter Karkus, Zurich (CH); Boris Ivanovic, Mountain View, CA (US); Xinshuo Weng, North York (CA); Marco Pavone, Stanford, CA (US)

(21) Appl. No.: 18/354,892

(22) Filed: Jul. 19, 2023

Related U.S. Application Data
(60) Provisional application No. 63/429,425, filed on Dec. 1, 2022.

(51) Int. Cl. B60W 60/00

(52) U.S. Cl. CPC B60W 60/00272; B60W 60/0011; B60W 2554/4046; B60W 2554/80

(57) ABSTRACT

In various examples, policy planning using behavior models for autonomous and semi-autonomous systems and applications is described herein. Systems and methods are disclosed that determine a policy for navigating a vehicle, such as a semi-autonomous vehicle or an autonomous vehicle (or other machine), where the policy allows for multistage reasoning that leverages future reactive behaviors of one or more other objects. For instance, a first behavior model (e.g., a trajectory tree) may be generated that represents candidate trajectories for the vehicle and one or more second behavior models (e.g., one or more scenario trees) may be generated that respectively represent future behaviors of the other object(s). The first behavior model and the second behavior model(s) may then be processed, such as in a closed-loop simulation based on a realistic data-driven traffic model, to determine the policy for navigating the vehicle.

### CROSS-REFERENCE TO RELATED APPLICATIONS

This application claims the benefit of U.S. Provisional Application No. 63/429,425, filed on Dec. 1, 2022, which is hereby incorporated by reference in its entirety.

### BACKGROUND

Designing a system to drive a vehicle autonomously without supervision at a level of safety required for practical acceptance is tremendously difficult. An autonomous vehicle should at least be capable of performing as a functional equivalent of an attentive driver—who draws upon a perception and action system that has an incredible ability to identify and react to dynamic and static obstacles in a complex environment—to navigate a path safely in view of other objects or structures along its path. As such, among the most important tasks required of an autonomous system is determining drivable paths within complex environments that an autonomous vehicle may encounter. Because of this, numerous systems have been generated for determining these drivable paths for autonomous vehicles within environments.

A key challenge of motion planning for autonomous vehicles is reasoning about interactions between the autonomous vehicles and closely located objects. As such, the task is usually divided into two subproblems: trajectory predictions for the other objects; and then motion planning predictions for the autonomous vehicles. For the motion planning predictions, some conventional systems use the trajectory predictions of the other objects to determine a single trajectory for an autonomous vehicle that minimizes an expected cost over all the predicted futures within the planning horizon. However, such trajectory planning may lead to overly conservative plans since it ignores new information that is acquired about the other objects in subsequent timesteps, such as the effects of the autonomous vehicle actions on the other objects.

As such, some conventional systems have been developed that use various contingency planning algorithms to approximate policy planning for autonomous vehicles. However, such conventional systems use simple differentiable prediction models for the autonomous vehicles and/or the other objects. For example, these conventional systems may not generate high-quality trajectories for the autonomous vehicles or use deep-learning prediction models when determining the behaviors of the other objects. Additionally, these conventional systems only use single stage reasoning to determine trajectories for autonomous vehicles and, as such, do not navigate the autonomous vehicles based on the actual future behaviors of the objects.

### SUMMARY

Embodiments of the present disclosure relate to policy planning using behavior models for autonomous or semi-autonomous systems and applications. Systems and methods are disclosed that determine a policy for navigating a vehicle, such as a semi-autonomous vehicle or an autonomous vehicle (or other machine), where the policy allows for multistage reasoning that leverages future reactive behaviors of one or more other objects. For instance, a first behavior model (e.g., a trajectory tree) may be generated that represents candidate trajectories for the vehicle and one or more second behavior models (e.g., one or more scenario trees) may be generated that respectively represent future behaviors of the other object(s). The first behavior model and the second behavior model(s) may then be processed, such as in a closed-loop simulation based on a realistic data-driven traffic model, to determine the policy for navigating the vehicle. As described in more detail herein, the policy may allow for the vehicle to select between candidate trajectories at various stages based on the actual behaviors of the objects.

In contrast to conventional systems, such as those described above that determine a single trajectory for a vehicle to perform based on predicted behaviors of the other objects, the current systems, in some embodiments, are able to determine the policy that provides for multistage reasoning based on the future reactive behaviors of the other objects. By determining a policy rather than a single trajectory, the current systems may still determine safe trajectories for the vehicle to navigate (e.g., trajectories that avoid collisions with the other objects) while also being less conservative in order to better recreate actual human driving. Additionally, in contrast to conventional systems, such as those described above that use contingency planning algorithms, the current systems, in some embodiments, may use deep-learning prediction models to generate multi-modal predictions of the environment (e.g., the scenario tree structure(s)) that better predict the behaviors of the other objects. Furthermore, in contrast to such conventional systems that only use single stage reasoning, the current systems, in some embodiments, may gain determine policies that provide multistage reasoning based on the possible future behaviors of the other object(s), which improves the overall navigating of the vehicle.

### BRIEF DESCRIPTION OF THE DRAWINGS

The present systems and methods for policy planning using behavior models for autonomous and semi-autonomous systems and applications are described in detail below with reference to the attached drawing figures, wherein:

FIG. 1A illustrates an example data flow diagram for a process of performing policy planning using behavior models, in accordance with some embodiments of the present disclosure;

FIG. 1B is a data flow diagram illustrating a process for training a machine learning model(s) to perform policy planning using behavior models, in accordance with some embodiments of the present disclosure;

FIGS. 2A-2C illustrate examples of generating environmental data and history data associated with an environment, in accordance with some embodiments of the present disclosure;

FIG. 3 illustrates an example of a behavior model that represents candidate trajectories for a vehicle at various future time intervals (future stages), in accordance with some embodiments of the present disclosure;

FIG. 4 illustrates an example of a behavior model that represents candidate behaviors for one or more objects at various future time intervals (future stages), in accordance with some embodiments of the present disclosure;

FIG. 5 illustrates an example of a vehicle executing a policy associated with navigating within an environment, in accordance with some embodiments of the present disclosure;

FIG. 6 is a flow diagram showing a first method for determining, using behavior models, a policy for navigating a machine, in accordance with some embodiments of the present disclosure;

FIG. 7 is a flow diagram showing a second method for determining, using behavior models, a policy for navigating a machine, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

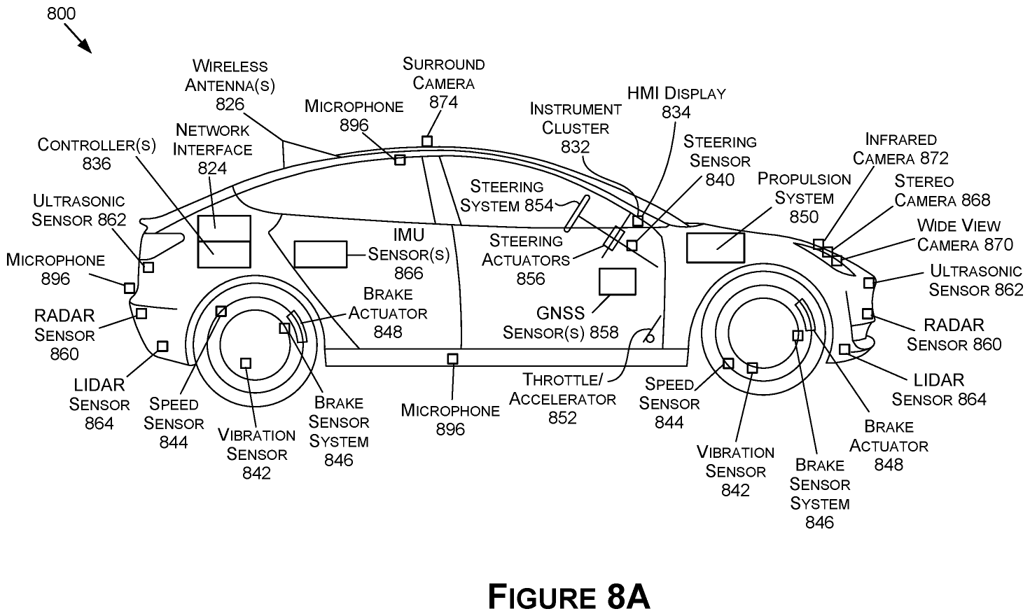

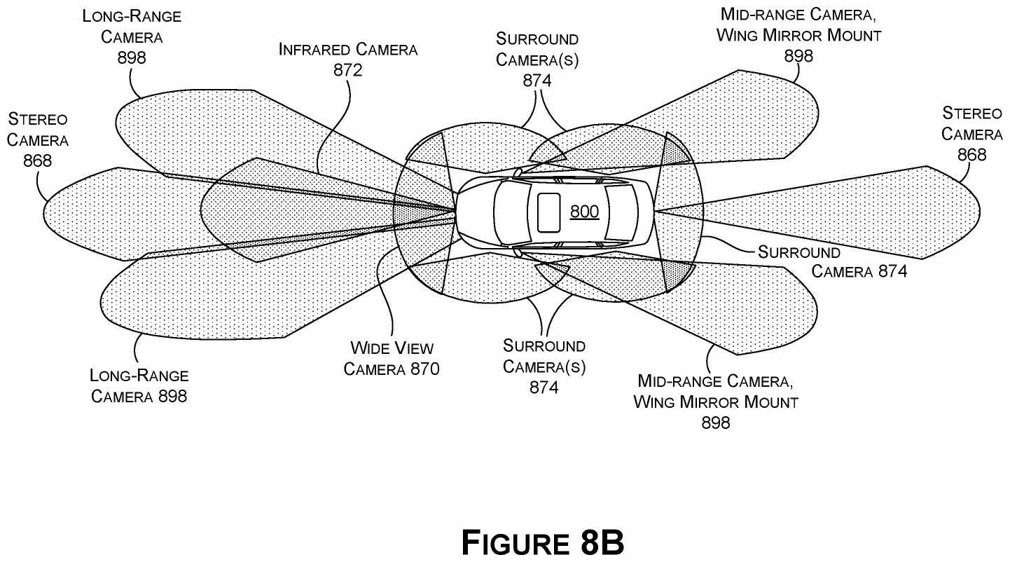

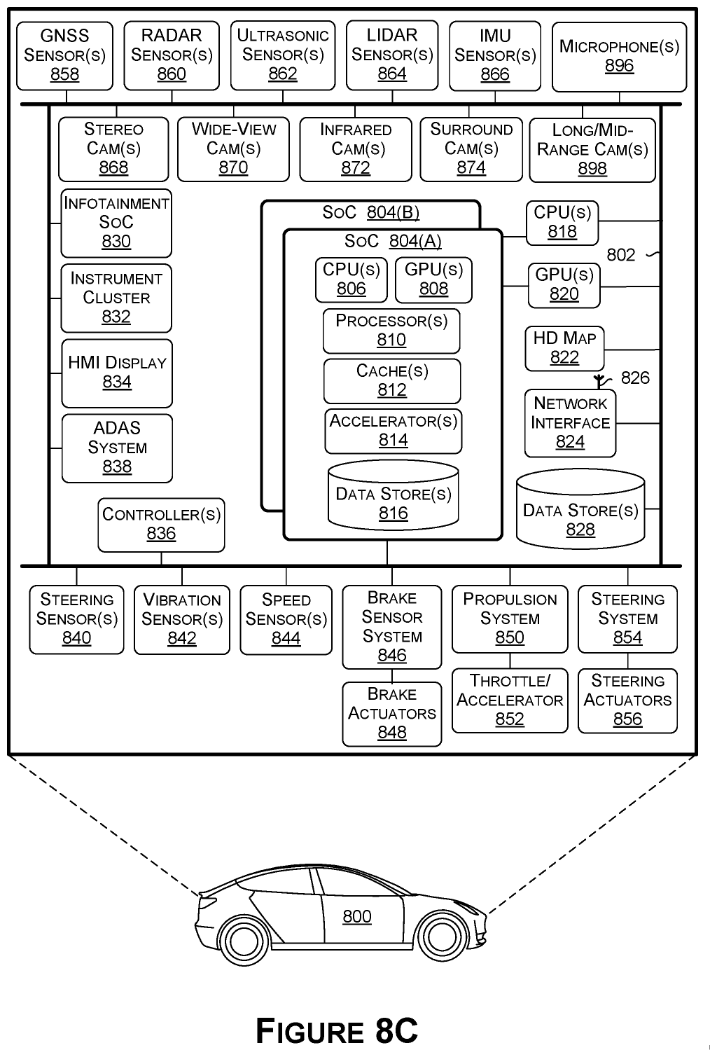

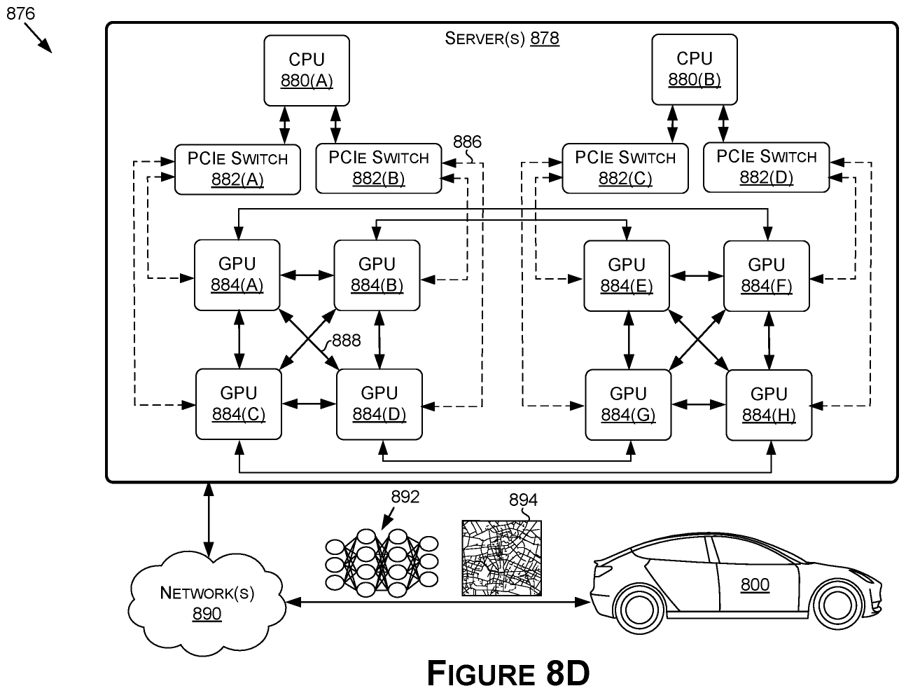

Systems and methods are disclosed related to policy planning using behavior models for autonomous and semi-autonomous systems and applications. Although the present disclosure may be described with respect to an example autonomous or semi-autonomous vehicle or machine 800 (alternatively referred to herein as “vehicle 800” or “ego-machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to path planning, this is not intended to be limiting, and the systems and methods described herein may be used in augmented reality, virtual reality, mixed reality, robotics, security and surveillance, autonomous or semi-autonomous machine applications, and/or any other technology spaces where path planning may be used.

For instance, a system(s) may receive sensor data generated using one or more sensors of a vehicle. As described herein, the sensor data may include, but is not limited to, image data generated using one or more image sensors, RADAR data generated using one or more RADAR sensors, LiDAR data generated using one or more LiDAR sensors, location data generated using one or more location sensors (e.g., a Global Positioning System), and/or any other type of sensor data generated using any other type of sensor. The system(s) may then use the sensor data and/or map data representative of an environment for which the vehicle is navigating to generate first data representative of a geometry (e.g., a road geometry) associated with the environment. For instance, the road geometry may indicate the locations of static objects, such as roads, curbs, structures (e.g., buildings, homes, etc.), traffic signs, and/or the like. Additionally, the system(s) may use the sensor data to generate second data representative of history information associated with the vehicle and/or one or more other objects, such as past locations, current locations, and/or past trajectories associated with the vehicle and/or the other object(s).

The system(s) may then use one or more first components (e.g., a motion sampler, a machine learning model, a neural network, etc.) to determine, using at least a portion of the first data and/or at least a portion of the second data, a first behavior model (e.g., a trajectory tree) representing candidate trajectories for the vehicle at various future time intervals (future stages). For example, the first behavior model may include at least one or more first candidate trajectories for the vehicle to navigate during a first future time interval (e.g., during a first stage), one or more second candidate trajectories for the vehicle to navigate during a second future time interval (e.g., during a second stage), one or more third candidate trajectories for the vehicle to navigate during a third future time interval (e.g., during a third stage), and/or so forth. In some examples, the candidate trajectories for the various future time intervals are based on one another. For example, a first candidate trajectory for the first future time interval may start at a first location and end at a second location, a second candidate trajectory for the second future time interval may start at the second location and end at a third location, and a third candidate trajectory for the second future time interval may start at the second location and end at a fourth location.

The system may also use one or more second components (e.g., a prediction model, a machine learning model, a neural network, etc.) to determine, using at least a portion of the first data, at least a portion of the second data, and/or the first behavior model, a second behavior model (e.g., a scenario tree) representing candidate behaviors for the object(s) at the various future time intervals. For example, the second behavior model may include at least one or more first candidate behaviors for the object(s) during the first future time interval (e.g., during the first stage), one or more second candidate behaviors for the object(s) during the second future time interval (e.g., during the second stage), one or more third candidate behaviors for the object(s) during the third future time interval (e.g., during the third stage), and/or so forth. In some examples, the candidate behaviors for the various future time intervals are based on one another. For example, a first candidate behavior for the first future time interval may start at a fifth location and end at a sixth location, a second candidate behavior for the second future time interval may start at the sixth location and end at a seventh location, and a third candidate behavior for the second future time interval may start at the sixth location and end at an eighth location.

In some examples, the system(s) (e.g., the second component(s)) may generate multiple second behavior models based on the first behavior model. For example, and as described herein, the first behavior model may include a number of branches, where a respective branch represents a trajectory that the vehicle may navigate over an entire future time interval that includes the future time intervals. As such, the system(s) may generate a respective second behavior model for one or more (e.g., each) of the branches of the first behavior model. Because of this, the respective behavior model may represent the behaviors that the object(s) may perform based on the vehicle navigating according to a specific trajectory within the environment.

The system(s) may then use one or more third components (e.g., a dynamic program, a machine learning model, a neural network, etc.) to determine, using the first behavior model and the second behavior model(s), a policy for the vehicle to follow when navigating the environment. In some examples, the system(s) may use a specific process, such as a Markov Decision Process (MDP), to determine the policy. As described herein, the policy may allow for multistage reasoning that leverages the future reactive behaviors of the object(s). For example, the policy may indicate that the vehicle is to navigate a first trajectory during the first future time interval. The policy may then indicate that the vehicle is to navigate a second trajectory during the second future time interval when the object(s) performs one or more second behaviors during the second future time interval or navigate a third trajectory during the second future time interval when the object(s) performs one or more second behaviors during the second future time interval. Additionally, the policy may indicate one or more additional reasonings associated with one or more additional time intervals.

By using a policy instead of just a single trajectory to navigate the vehicle, the system(s) may, in some examples, cause the vehicle to navigate more closely to an actual driver. For example, while driving along a road with another vehicle, a driver may continue to monitor the actual behavior of the other vehicle and react accordingly (e.g., determine trajectories) rather than just selecting a single trajectory to navigate over a future period of time. Similarly, the policy may allow for the vehicle to continue determining different trajectories to follow based on the actual behavior of the other object(s) within the environment.

In some examples, the system(s) may continue to perform these processes at various time intervals. For example, such as during the first time interval when the vehicle is navigating the first trajectory indicated by the policy, the system(s) may perform these processes again to determine a new policy for the vehicle to follow when navigating the environment. The vehicle may then switch from following the first policy to following the second policy. This process may then continue to repeat as the vehicle is navigating around the environment.

As described herein, history information and/or behavior models (e.g., the trajectory tree and/or the scenario tree(s)) may be associated with time intervals. A time interval may include, but is not limited to, 0.1 seconds, 0.2 seconds, 0.5 seconds, 1 second, 2 seconds, 3 seconds, 4 seconds, 5 seconds, and/or any other time period. Additionally, a total time interval may include all of the time intervals. For example, if the trajectory tree includes four stages, where each stage is associated with a time interval of 0.5 seconds, then the total time interval may include 2 seconds.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems implementing language models—such as one or more large language models (LLMs), systems for performing conversational AI operations, systems for performing light transport simulation, systems for performing collaborative content creation for 3D assets, systems implemented at least partially using cloud computing resources, and/or other types of systems.

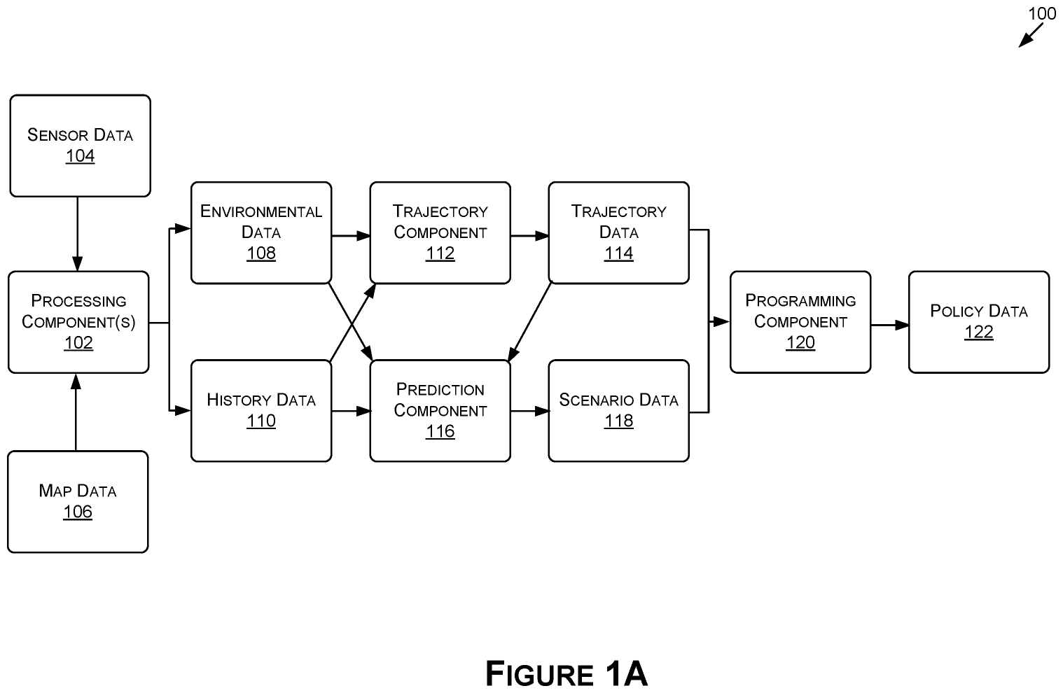

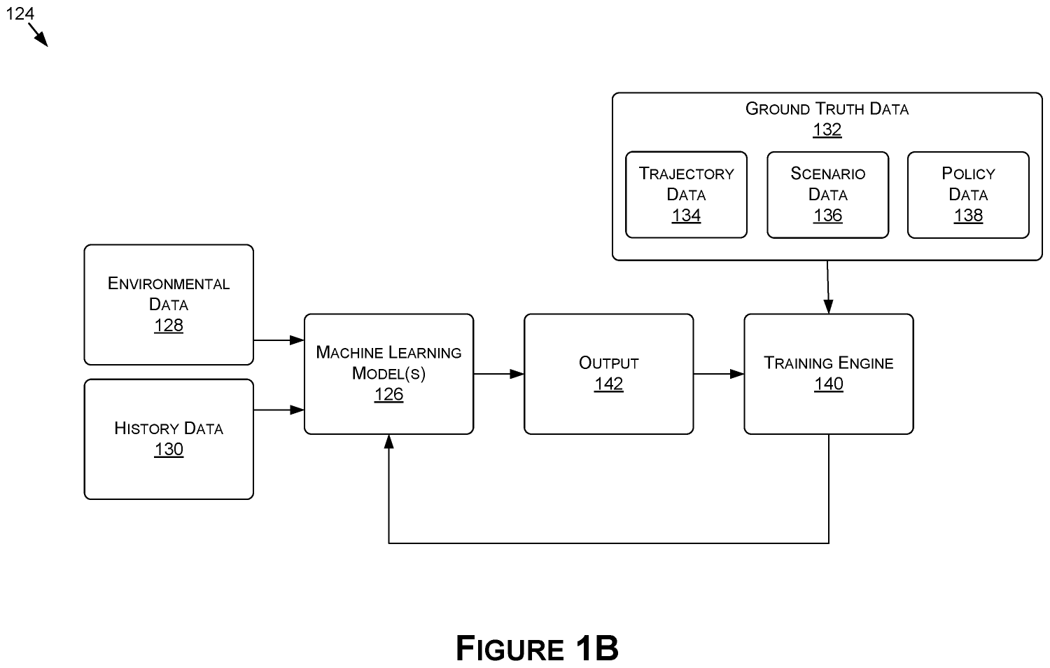

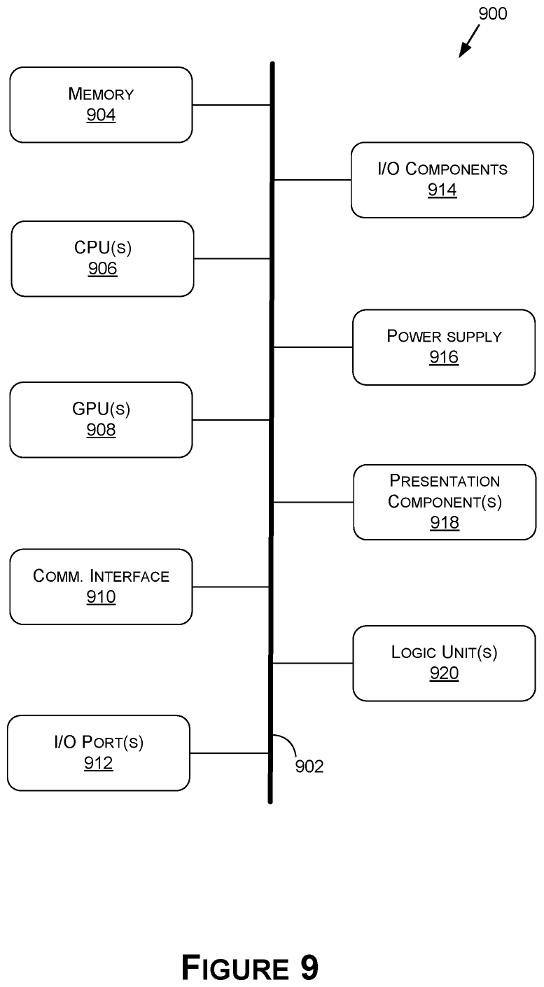

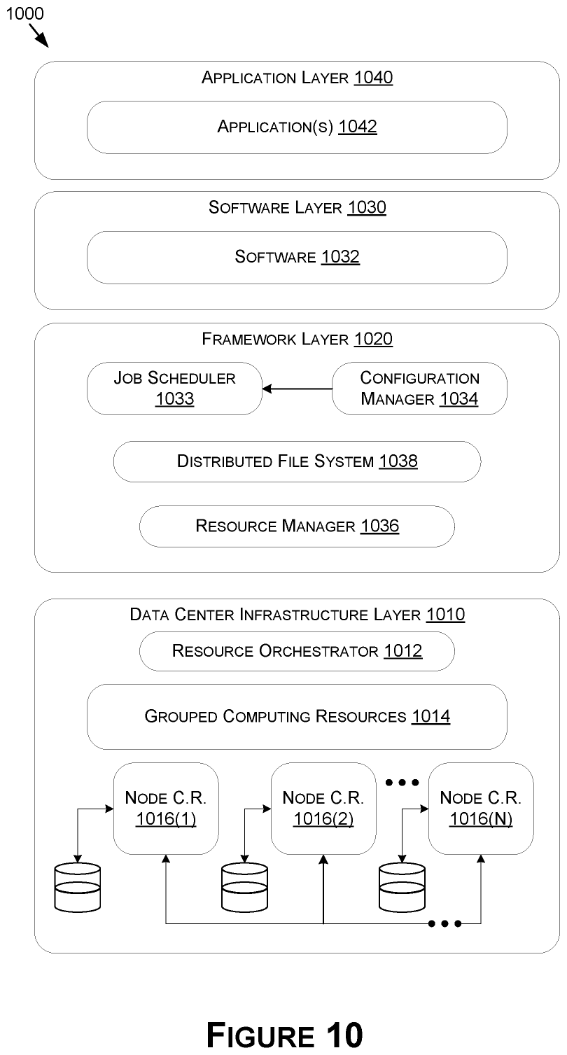

With reference to FIG. 1A, FIG. 1A illustrates an example data flow diagram for a process 100 of performing policy planning using behavior models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous or semi-autonomous vehicle or machines 800 of FIGS. 8A-8D, example computing device 900 of FIG. 9, and/or example data center 1000 of FIG. 10.

The process 100 may include one or more processing components 102 receiving sensor data 104 generated using one or more sensors of a vehicle and/or map data 106. As described herein, the sensor data 104 may include, but is not limited to, image data generated using one or more image sensors, RADAR data generated using one or more RADAR sensors, LiDAR data generated using one or more LiDAR sensors, location data generated using one or more location sensors (e.g., a Global Navigation Satellite System (GNSS)), pose information generated using one or more inertial measurement unit (IMU) sensors, speed data generated using one or more tire or wheel sensors, visual odometry data, and/or any other type of sensor data generated using any other type of sensor. Additionally, the map data 106 may represent one or more maps of one or more environments for which the vehicle may navigate. In some examples, a map may indicate at least the locations of static objects within an environment, such as roads, curbs, structures (e.g., buildings, homes, etc.), traffic signs and/or markings, and/or any other static object.

The process 100 may then include the processing component(s) 102 generating, based at least on the sensor data 104 and/or the map data 106, environmental data 108 representing an environment for which the vehicle is navigating. For instance, the environmental data 108 may represent the layout of the environment (e.g., a road geometry), such as the layout of the static objects (e.g., the roads) within the environment. In some examples, the environmental data 108 may represent a map, where the map indicates the layout of the environment. In some examples, the environmental data 108 is generated based on a current location of the vehicle. For example, the environmental data 108 may be generated such that the current location of the vehicle is at a center of the layout of the environment (e.g., the layout of the environment is generated around the current location of the vehicle).

The process 100 may also include the processing component(s) 102 generating, based at least on the sensor data 104 and/or the map data 106, history data 110 representing history information associated with the vehicle and/or one or more other objects located within the environment. For instance, the history data 110 may represent one or more past locations associated with the vehicle over a past time interval, a past trajectory associated with the vehicle over the past time interval, a current location associated with the vehicle, a velocity associated with the vehicle, an acceleration associated with the vehicle, a direction of travel associated with the vehicle, a turning direction associated with the vehicle, and/or any other information associated with the vehicle. Additionally, or alternatively, the history data 110 may represent one or more past locations associated with the object(s) over the past time interval, one or more past trajectories associated with the object(s) over the past time interval, one or more current locations associated with the object(s), one or more velocities associated with the object(s), one or more accelerations associated with the object(s), one or more directions of travel associated with the object(s), one or more turning directions associated with the object(s), and/or any other information associated with the object(s). As described herein, the past time interval may include, but is not limited to, 1 second, 2 seconds, 3 seconds, 4 seconds, 5 seconds, and/or any other time interval.

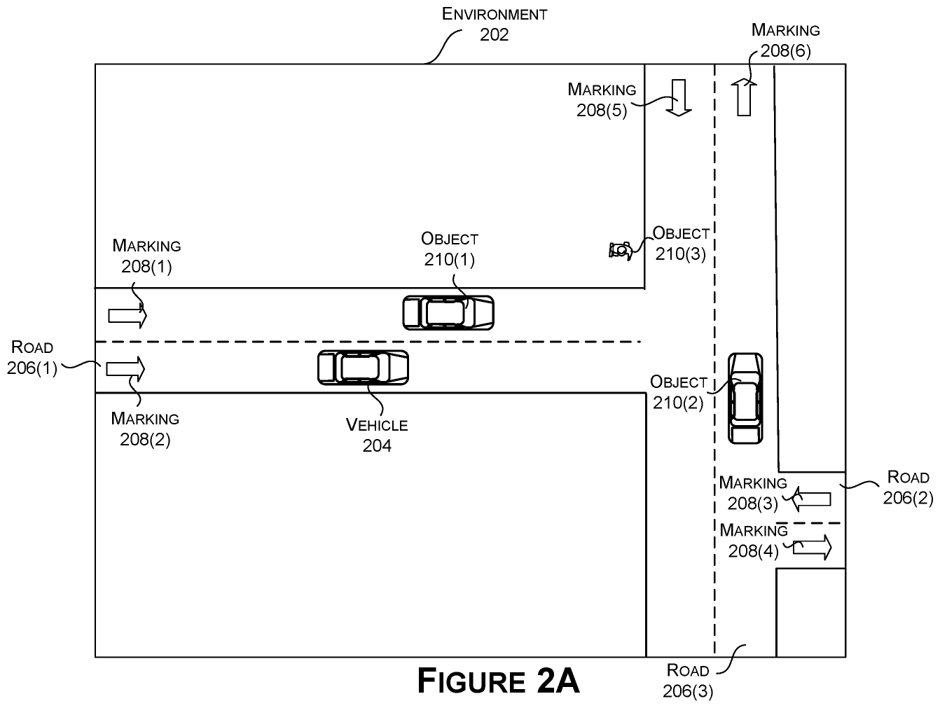

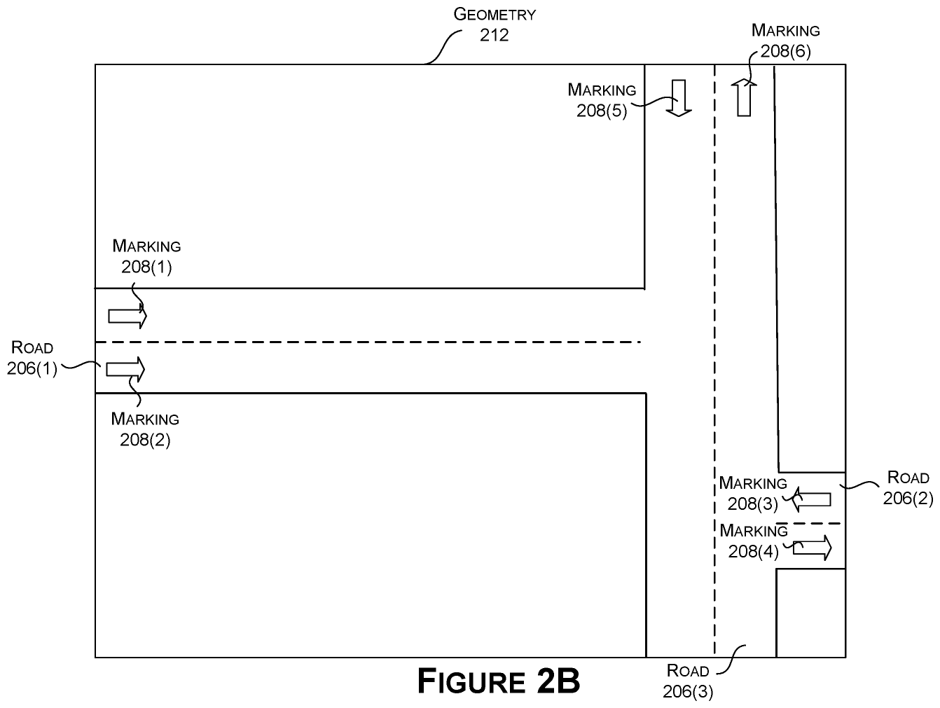

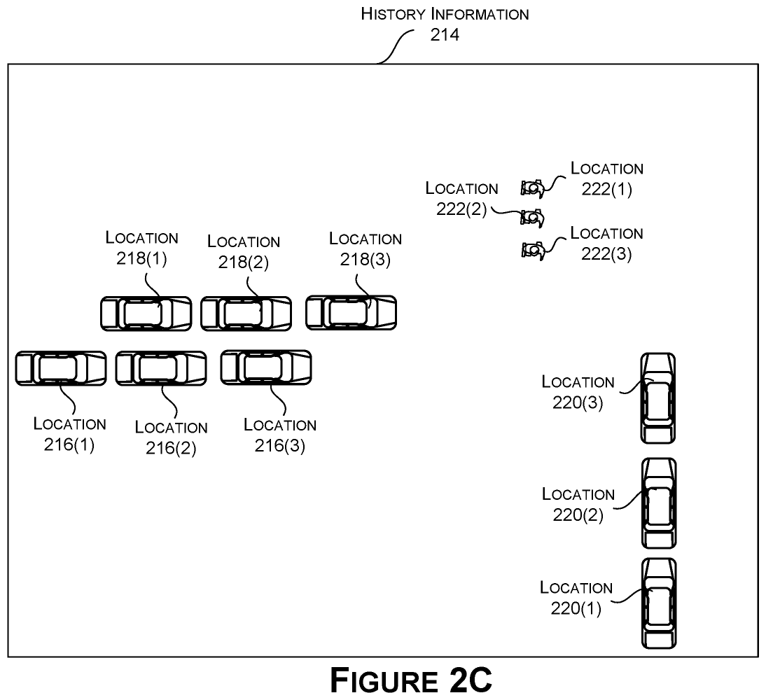

For instance, FIGS. 2A-2C illustrate examples of generating environmental data and history data associated with an environment 202, in accordance with some embodiments of the present disclosure. As shown by the example of FIG. 2A, a vehicle 204 may be navigating around the environment 202 that includes three roads 206(1)-(3) (also referred to singularly as “road 206” or in plural as “roads 206”). In the example of FIG. 2A, the first road 206(1) includes a one-way road (e.g., indicated by road markings 208(1)-(2)), the second road 206(2) includes a two-way road (e.g., indicated by road markings 208(3)-(4)), and the third road 206(3) includes a two-way road (e.g., indicated by road markings 208(5)-(6)). The example of FIG. 2A further illustrates three objects 210(1)-(3) (also referred to singularly as “object 210” or in plural as “objects 210”) located within the environment 202. For instance, the first object 210(1) may include another vehicle navigating along the same first road 206(1) as the vehicle 204, the second object 210(2) may include another vehicle navigating along the third road 206(3), and the third object 210(3) may include a pedestrian walking towards the first road 206(1).

FIG. 2B illustrates an example of a geometry 212 that may be generated by the processing component(s) 102, where the geometry 212 may be represented by the environmental data 108. As shown, the geometry 212 indicates at least the locations of the roads 206 within the environment 202. Additionally, the geometry 212 may further indicate the locations of traffic signs and/or traffic markings, such as the road markings 208(1)-(6).

Next, FIG. 2C illustrates an example of history information 214 associated with the environment 202, where the history information 214 may be represented by the history data 110. As shown, the history information 214 indicates past locations 216(1)-(2) as well as a current location 216(3) associated with the vehicle 204 (e.g., a past trajectory associated with the vehicle 204). The history information 214 further includes past locations 218(1)-(2) as well as a current location 218(3) associated with the first object 210(1) (e.g., a past trajectory associated with the first object 210(1)), past locations 220(1)-(2) as well as a current location 220(3) associated with the second object 210(2) (e.g., a past trajectory associated with the second object 210(2)), and past locations 222(1)-(2) as well as a current location 222(3) associated with the third object 210(3) (e.g., a past trajectory associated with the third object 210(3)).

Referring back to the example of FIG. 1A, the process 100 may include a trajectory component 112 using at least a portion of the environmental data 108 and/or at least a portion of the history data 110 to generate trajectory data 114 associated with the vehicle. As described herein, the trajectory component 112 may include, but is not limited to, a motion sampler, a machine learning model, a neural network, and/or any other type of component that is capable of generating the trajectory data 114.

The trajectory data 114 may represent a first behavior model, such as a trajectory tree, that indicates candidate trajectories for the vehicle at various future time intervals (future stages). For example, the first behavior model may indicate at least one or more first candidate trajectories for the vehicle to navigate during a first future time interval (e.g., during a first stage), one or more second candidate trajectories for the vehicle to navigate during a second future time interval (e.g., during a second stage), one or more third candidate trajectories for the vehicle to navigate during a third future time interval (e.g., during a third stage), and/or so forth. In some examples, the candidate trajectories for the various future time intervals are based on one another. For example, a first candidate trajectory for the first future time interval may start at a first location and end at a second location, a second candidate trajectory for the second future time interval may start at the second location and end at a third location, and a third candidate trajectory for the second future time interval may start at the second location and end at a fourth location.

For more detail about generating trajectory trees, the trajectory component 112 may generate a set of dynamically feasible trajectory options for the vehicle (e.g., a planner system of the vehicle) to consider and organize the trajectory options using a trajectory tree. In some examples, the trajectory component 112 initially samples a set of terminal points and then finds a feasible trajectory to a terminal point. The terminal points may be sampled from a fixed set of acceleration-steering values, as well as along (and/or proximate to) lane centerlines when lane information is available (e.g., when the environmental data 108 represents the lane information). The trajectory component 112 may then fit a spline from the current location of the vehicle to the terminal point.

For instance, given the current vehicle state sᵣ[0]=[X₀,Y₀,v₀, [symbol] and a terminal condition sᵣ[T] =[X_{T},Y_{T},v_{T}, [symbol] , the trajectory component 112 may use two separate polynomials X[t] and Y[t] to parameterize the X, Y coordinates such that the resulting spline connects the two points and the following boundary conditions are met:

$$X [ 0 ] = {X}_{0} \qquad ( 1 )$$

$$Y [ 0 ] = {Y}_{0} \qquad ( 2 )$$

$$\dot{X} [ 0 ] = {v}_{0} cos {φ}_{0} \qquad ( 3 )$$

$$\dot{Y} [ 0 ] = {v}_{0} sin {φ}_{0} \qquad ( 4 )$$

$$X [ T ] = {X}_{T} \qquad ( 5 )$$

$$Y [ T ] = {Y}_{T} \qquad ( 6 )$$

$$\dot{X} [ T ] = {v}_{T} cos {φ}_{T} \qquad ( 7 )$$

$$\dot{Y} [ T ] = {v}_{T} sin {φ}_{T} \qquad ( 8 )$$

With the boundary conditions on each polynomial, two 3^{rd} order (e.g., cubic) polynomials may be uniquely determined, which may allow the trajectory component 112 to directly compute the coefficient of X[t] and Y[t] in closed-form and also calculate the trajectory from X[t] and Y[t]. In some examples, the trajectory component 112 may then drop the trajectories that violate one or more dynamic constraints (e.g., turning angle constraints, velocity constraints, acceleration constraints, etc.).

In some examples, the trajectory component 112 may build the trajectory tree stage by stage, such as by starting at a current state as root r⁰. The trajectory component 112 may then set an upper bound on the number of children a node may have and randomly drop child nodes if the upper bound is exceeded. As described herein, the upper bound may include, but is not limited to, one child, two children, three children, five children, ten children, and/or any other number of children. In some examples, the trajectory component 112, in one or more stages (e.g., each stage), generates child branches in parallel such that the time complexity is linear in stage numbers.

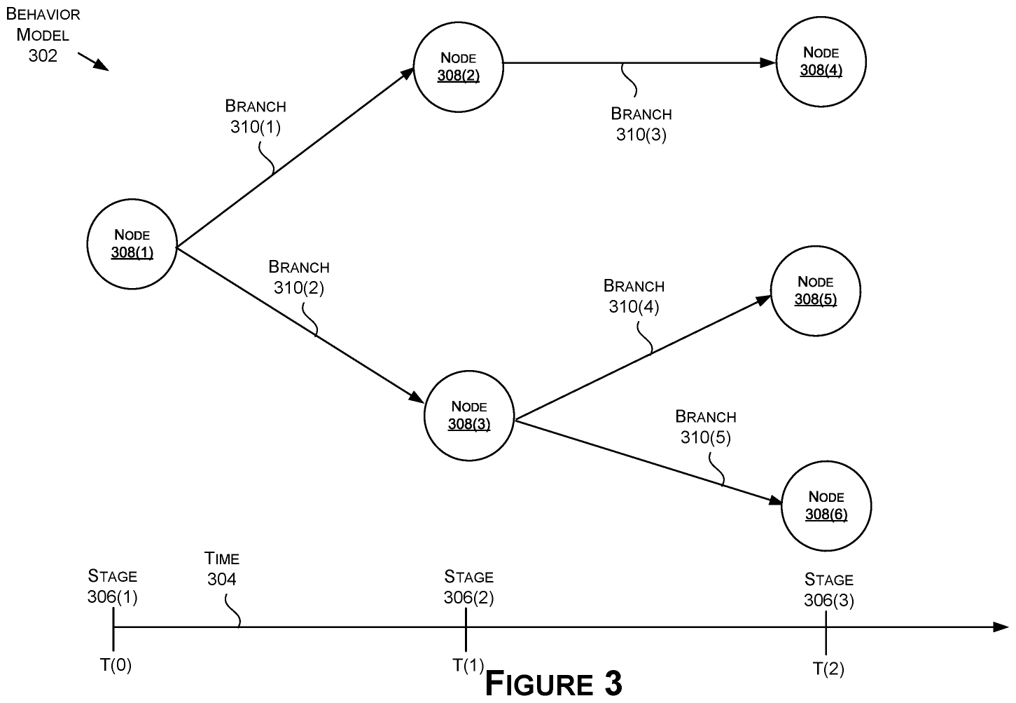

For instance, FIG. 3 illustrates an example of a behavior model 302 that represents candidate trajectories for a vehicle at various future time intervals (future stages), in accordance with some embodiments of the present disclosure. In the example of FIG. 3, the behavior model 302 may include a trajectory tree that includes, over a period of time 304, three stages 306(1)-(3) (also referred to singularly as “stage 306” or in plural as “stages 306”). For instance, the trajectory tree may include the first stage 306(1) associated with a first time T(0) (e.g., a current time), the second stage 306(2) associated with a second time T(1), and the third stage 306(3) associated with a third time T(2). While the trajectory tree from the example of FIG. 3 includes the three stages 306, in other examples, a trajectory tree may include any number of stages.

The trajectory tree further includes a first node 308(1) associated with the first stage 306(1), a second node 308(2) and a third node 308(3) associated with the second stage 306(2), where the second node 308(2) and the third node 308(3) include child nodes of the first node 308(1), and a fourth node 308(4), a fifth node 308(5), and a sixth node 308(6) associated with the third stage 306(3), where the fourth node 308(4) includes a child node of the second node 308(2) and the fifth node 308(5) and the sixth node 308(6) include child nodes of the third node 308(3). In some examples, one or more of the nodes 308(1)-(6) may represent a respective state associated with the vehicle, such as a location within the environment 202 for which the vehicle 204 is to navigate.

Additionally, the trajectory tree may include a first branch 310(1) that represents a first candidate trajectory between the first time T(0) and the second time T(1), a second branch 310(2) that represents a second candidate trajectory between the first time T(0) and the second time T(1), a third branch 310(3) that represents a third candidate trajectory between the second time T(1) and the third time T(2), a fourth branch 310(4) that represents a fourth candidate trajectory between the second time T(1) and the third time T(2), and a fifth branch 310(5) that represents a fifth candidate trajectory between the second time T(1) and the third time T(2). As such, the trajectory tree may represent a first total candidate trajectory that includes the first candidate trajectory and the third candidate trajectory (e.g., from a first location associated with the first node 308(1) to a second location associated with the second node 308(2) and finally a fourth location associated with the fourth node 308(4)), a second total candidate trajectory that includes the second candidate trajectory and the fourth candidate trajectory (e.g., from the first location associated with the first node 308(1) to a third location associated with the third node 308(3) and finally a fifth location associated with the fifth node 308(5)), and a third total candidate trajectory that includes the second candidate trajectory and the fifth candidate trajectory (e.g., from the first location associated with the first node 308(1) to the third location associated with the third node 308(3) and finally a sixth location associated with the sixth node 308(6)).

Referring back to the example of FIG. 1A, the process 100 may include a prediction component 116 that uses at least a portion of the environmental data 108, at least a portion of the history data 110, and/or at least a portion of the trajectory data 114 to generate scenario data 118 associated with the other object(s). As described herein, the prediction component 116 may include, but is not limited to, a prediction model, a machine learning model, a neural network, and/or any other type of component that is capable of generating the scenario data 118. For example, the prediction component 116 may include (1) a rasterized model with a convolutional neural network (CNN) backbone and a convolutional variational autoencoder (CVAE), (2) a PredictionNet model with a Unet backbone, (3) an Agentformer model, and/or any other type of prediction model.

As described herein, the scenario data 118 may represent a second behavior model, such as a scenario tree, that represents candidate behaviors for one or more objects located within the environment at the various future time intervals. As described herein, a candidate behavior may include, but is not limited to, a candidate trajectory, a candidate velocity, a candidate acceleration, and/or any other behavior associated with motion of an object within an environment. For an example, the second behavior model may include at least one or more first candidate behaviors for the object(s) during the first future time interval (e.g., during the first stage), one or more second candidate behaviors for the object(s) during the second future time interval (e.g., during the second stage), one or more third candidate behaviors for the object(s) during the third future time interval (e.g., during the third stage), and/or so forth. In some examples, the candidate behaviors for the various future time intervals are based on one another. For example, a first candidate behavior for the first future time interval may start at a fifth location and end at a sixth location, a second candidate behavior for the second future time interval may start at the fifth location and end at a seventh location, and a third candidate behavior for the second future time interval may start at the fifth location and end at an eighth location.

In some examples, the prediction component 116 may generate scenario data 118 representing multiple second behavior models based at least on the first behavior model. For example, and as described herein, the first behavior model may include a number of branches, where a respective branch represents a trajectory that the vehicle may navigate over a total future time interval that includes the future time intervals. As such, the prediction component 116 may generate a respective second behavior model for one or more (e.g., each) of the branches of the first behavior model. As such, the respective behavior model may represent the behaviors that the object(s) may perform based on the vehicle navigating according to a specific trajectory within the environment.

For more details about generating scenario trees, the prediction component 116 may need to predict multiple modes of the trajectory distribution for one or more (each) of the objects. Additionally, in some examples, the predictions may need to be scene-centric, such as by outputting modes of the joint trajectory distribution of all relevant objects in the scene (e.g., the environment). As described herein, branches of the scenario tree correspond to modes of the joint distribution so that evaluations may be made between the vehicle candidate trajectories and joint futures effectively. Furthermore, in some examples, the predicted results from the prediction component 116 may need to be conditioned on the vehicle's hypothetical future motion.

Moreover, in some examples, the prediction component 116 may need to generate nodes of the prediction trajectory distribution in multiple stages. In other words, the scenario tree may contain multiple stages with one or more nodes (e.g., each node) branching into one or more child nodes (e.g., multiple child nodes) after one or more stages (e.g., each stage). This multistage prediction may allow an object to depend the object's future motion on the future multimodal observation of the environment (e.g., similar to the trajectory tree) and the stage number may be set as a design choice.

For a first example of the prediction component 116 generating a scenario tree, a rasterized model may use rasterized images as input, which contain the road geometry and the surrounding vehicles drawn as boxes around each object. The image is passed through a CNN backbone and then through a transformer for message passing among objects. Finally, a CVAE is used to generate multimodal predictions utilizing the dynamic models of the objects. To generate multistage predictions, the prediction component 116 may run the same model N times where N is the number of stages. For instance, after each stage, all nodes of the same stage are batched with updated features for the next stage.

For a second example of the prediction component 116 generating the scenario tree, the entire scene (e.g., environment) may be represented on a single image, which is then processed by a Unet backbone. The prediction for each object is then obtained by sampling the output image at the location of the object. This model may be naturally scene-centric and takes the interaction between objects into account. To generate multistage predictions, a re-rasterization procedure may be applied. Specifically, from stage 2 and forward, the prediction component 116 may use the same background image as stage 1 and update the object patches with the new agent history obtained by concatenating the original object history with predictions from early stages.

For a third example of the prediction component 116 generating the scenario tree, since an Agentformer model uses vectorized features, extending the model may need to take a moving window approach to obtain the object history for later stages and encode them before feeding them to the transformer. A local map patch may then be passed through a CNN encoder as part of the feature for each object, which does not change for all stages. To enable conditioning based on the vehicle, the prediction component 116 may simply remove the mask on the vehicle future so that the transformer has access to the information.

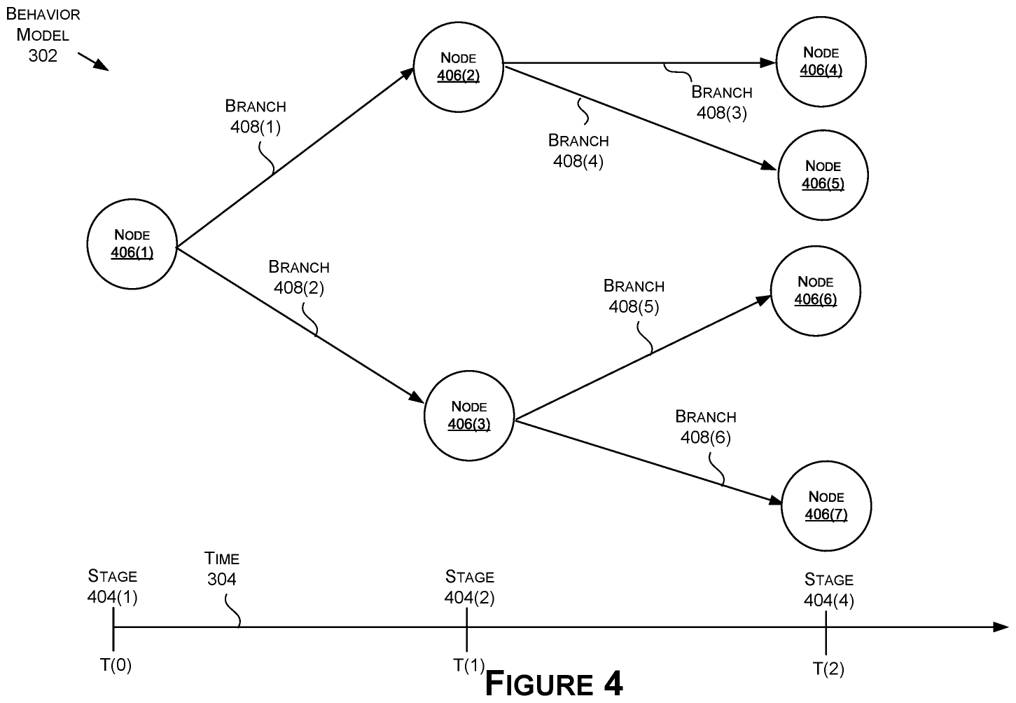

For instance, FIG. 4 illustrates an example of a behavior model 402 that represents candidate behaviors for one or more objects at various future time intervals (future stages), in accordance with some embodiments of the present disclosure. In the example of FIG. 4, the behavior model 402 may include a scenario tree that includes three stages 404(1)-(3) (also referred to singularly as “stage 404” or in plural as “stages 404”) over the period of time 304. For instance, the scenario tree may include the first stage 404(1) (which may correspond to the first stage 306(1)) associated with the first time T(0) (e.g., a current time), the second stage 404(2) (which may correspond to the second stage 306(2)) associated with the second time T(1), and the third stage 404(3) (which may correspond to the third stage 306(3)) associated with the third time T(2). While the scenario tree from the example of FIG. 4 includes the three stages 404, in other examples, a trajectory tree may include any number of stages.

The scenario tree further includes a first node 406(1) associated with the first stage 404(1), a second node 406(2) and a third node 406(3) associated with the second stage 404(2), where the second node 406(2) and the third node 406(3) include child nodes of the first node 406(1), and a fourth node 406(4), a fifth node 406(5), a sixth node 406(6), and a seventh node 406(7) associated with the third stage 404(3), where the fourth node 406(4) and the fifth node 406(5) include child nodes of the second node 406(2) and the sixth node 406(6) and the seventh node 406(7) include child nodes of the third node 406(3). In some examples, one or more of the nodes 406(1)-(7) may represent a respective state(s) associated with the object(s), such as a location(s) within the environment 202 for which the object(s) is to navigate.

Additionally, the scenario tree may include a first branch 408(1) that represents a first candidate trajectory between the first time T(0) and the second time T(1), a second branch 408(2) that represents a second candidate trajectory between the first time T(0) and the second time T(1), a third branch 408(3) that represents a third candidate trajectory between the second time T(1) and the third time T(2), a fourth branch 408(4) that represents a fourth candidate trajectory between the second time T(1) and the third time T(2), a fifth branch 408(5) that represents a fifth candidate trajectory between the second time T(1) and the third time T(2), and a sixth branch 408(6) that represents a sixth candidate trajectory between the second time T(1) and the third time T(2). As such, the scenario tree may represent a first total candidate trajectory that includes the first candidate trajectory and the third candidate trajectory (e.g., from a first location associated with the first node 406(1) to a second location associated with the second node 406(2) and finally a fourth location associated with the fourth node 406(4)), a second total candidate trajectory that includes the first candidate trajectory and the fourth candidate trajectory (e.g., from the first location associated with the first node 406(1) to the second location associated with the second node 406(2) and finally a fifth location associated with the fifth node 406(5)), a third total candidate trajectory that includes the second candidate trajectory and the fifth candidate trajectory (e.g., from the first location associated with the first node 406(1) to a third location associated with the third node 406(3) and finally a sixth location associated with the sixth node 406(6)), and a fourth total candidate trajectory that includes the second candidate trajectory and the sixth candidate trajectory (e.g., from the first location associated with the first node 406(1) to the third location associated with the third node 406(3) and finally a seventh location associated with the seventh node 406(7)).

While the example of FIG. 4 illustrates generating a single behavior model 402, in other examples, the prediction component 116 may generate multiple behavior models. For example, the prediction component 116 may generate the behavior model 402 using the first total candidate trajectory from the example of FIG. 3, a second behavior model using the second total candidate trajectory from the example of FIG. 3, and a third behavior model using the third total candidate trajectory from the example of FIG. 3.

Referring back to the example of FIG. 1A, the process 100 may include using a programming component 120 to determine, based at least on the trajectory data 114 and the scenario data 118, policy data 122 representing a policy for the vehicle to follow when navigating the environment. As described herein, the programming component 120 may include a dynamic programmer, a machine learning model, a neural network, and/or any other type of component that is able to generate the policy data 122 representing the policy. In some examples, the programming component 120 may use a specific process, such as a MDP, to determine the policy. Additionally, as described herein, the policy may allow for multistage reasoning that leverages the future reactive behaviors of the object(s). For example, the policy may indicate that the vehicle is to navigate a first trajectory during the first future time interval. The policy may then indicate that the vehicle is to navigate a second trajectory during the second future time interval when the object(s) performs one or more first behaviors during the second future time interval or navigate a third trajectory during the second future time interval when the object(s) performs one or more second behaviors during the second future time interval. Additionally, the policy may indicate one or more additional reasonings during one or more additional time intervals.

For more details, and when the first behavior model includes the trajectory tree and the second behavior model(s) includes the scenario tree(s), the programming component 120 may take the trajectory tree r represented by the trajectory data 114, the scenario tree(s) e represented by the scenario data 118, and a cost function 1 to find the optimal motion policy for the vehicle. In some examples, the programming component 120 constructs a discrete MDP over the trajectory tree r and the scenario tree(s) e and finds an optimal policy through dynamic programming. More specifically, states of the MDP may include nodes of the trees that represent a joint vehicle and environment state, transitions may be given by the parent/child edges of the trees, and rewards may be defined by the integral of the cost over the time segment. The programming component 120 may then solve for the optimized finite-horizon policy for the discrete MDP using dynamic programming, such as by calculating the value function backwards in stages via a Bellman equation (and/or any other equation). In some examples, using the optimized policy, the programming component 120 and/or the vehicle may recover a continuous-time trajectory from the trajectory tree by executing the trajectory segments according to the policy. In practice, the vehicle may use a cost function l with standard terms for collision avoidance, lane keeping, goal reaching, and ride comfort.

For instance, the programming component 120 may minimize the expected cumulative cost over a horizon by the following equation:

[symbol]

=∫₀^{T}l(s(t),sₑ(t))dt (9)

In equation (9), l is the running cost function that depends on the vehicle state s and the environment state sₑ, and T is the planning horizon. The planning algorithm may thus operate on the two trees r and e with the same number of edges, so the cumulative cost may be rewritten as the following equation:

$$𝒥 = {\sum }_{i = 0}^{N} {L}_{i} ( {r}^{i} , {e}^{i} ) \qquad ( 10 )$$

$${L}_{i} ( {r}^{i} , {e}^{i} ) = {\int }_{{t}_{o}^{i}}^{{t}_{f}^{i}} l ( {s}^{{r}^{i}} ( t ) , {s}_{e}^{{e}^{i}} ( t ) ) dt \qquad ( 11 )$$

In equations (10)-(11), rⁱ and eⁱ are the nodes the vehicle and the environment take at stage i. Due to the stochasticity of the environment, the programming component 120 may aim to minimize the following equation:

$${𝔼}_{{e}^{0 : N}} [ {\sum }_{i = 0}^{N} {L}_{i} ( {r}^{i} , {e}^{i} ) ] \qquad ( 12 )$$

In equation (12), the expectation is on eⁱ, the actual branch the environment takes and the distribution is given as part of the prediction. For simplicity, the programming component 120 may present the results assuming e is not vehicle-conditioned, such that there is a single e, and later show that the results may be extended to the case with vehicle-conditioning.

The end result may be a policy that chooses which node to execute for the next stage given the current vehicle and environment node, such as rⁱ⁺¹=π*(rⁱ,eⁱ), where π* is the optimal policy. The form of the policy may be determined by the assumption about the information flow. For example, during stage i, the vehicle may observe the environment's response eⁱ and choose the motion of the vehicle among the child nodes of the current node rⁱ. To obtain the optimal policy, a value function is needed, such as by the following equation:

$$V ( {r}^{i} , {e}^{i} ) = {𝔼}_{{e}^{i : N}} [ {\sum }_{k = i}^{N} {L}_{k} ( {r}^{k} , {e}^{k} ) ] \qquad ( 13 )$$

Equation (13) may be the expected cost-to-go. As such, the programming component 120 may go backwards in stage and is trivial for the last stage:

V(r^{N},e^{N})=L_{N}(r^{N},e^{N}) (14)

For stage i, wherein i<N, the programming component 120 may use:

$$V ( {r}^{i} , {e}^{i} ) = {L}_{i} ( {r}^{i} , {e}^{i} ) + {min}_{{r}^{i + 1} ∈ Ch ( {r}^{i} )} {𝔼}_{{e}^{i + 1}} [ V ( {r}^{i + 1} , {e}^{i + 1} ) \vert {e}^{i} ] \qquad ( 15 )$$

In equation (15), since eⁱ⁺¹ is enumerable, the expectation is calculated as:

$${𝔼}_{{e}^{i + 1}} [ V ( {r}^{i + 1} , {e}^{i + 1} ) \vert {e}^{i} ] = {\sum }_{{e}_{j}^{i + 1} ∈ C h ( {e}^{i} )} ℙ [ {e}_{j}^{i + 1} \vert {e}^{i} ] V ( {r}^{i + 1} , {e}_{j}^{i + 1} ) \qquad ( 16 )$$

In equation (16), the branching probability of the scenario tree may be given by the prediction component 116. As such, the equations may further be defined by:

$$\begin{matrix}Q ( {r}^{i + 1} , {e}^{i} ) := {L}_{i} ( {r}^{i} , {e}^{i} ) + {𝔼}_{{e}^{i + 1}} [ V ( {r}^{i + 1} , {e}^{i + 1} ) \vert {e}^{i} ] \\ = {L}_{i} ( {r}^{i} , {e}^{i} ) + {\sum }_{{e}_{j}^{i + 1} ∈ C h ( {e}^{i} )} ℙ [ {e}_{j}^{i + 1} \vert {e}^{i} ] V ( {r}^{i + 1} , {e}_{j}^{i + 1} )\end{matrix} \qquad ( 17 )$$

In equation (17) rⁱ=Par(rⁱ⁺¹). Additionally, and analogous to a Q function, b^{k+1} is the action that the programming component 120 may need to choose. As such, the value function may then be obtained backwards in stage by:

$$V ( {r}^{i} , {e}^{i} ) = \{ \begin{matrix}{L}_{i} ( {r}^{i} , {e}^{i} ) , & i = N \\ {min}_{{r}^{i + 1} ∈ Ch ( {r}^{i} )} Q ( {r}^{i + 1} , {e}^{i} ) & i < N\end{matrix} \qquad ( 18 )$$

The optimal policy may then be:

$${π}^{*} ( {r}^{i} , {e}^{i} ) = {arg min}_{{r}^{i + l} ∈ Ch ( {r}^{i} )} Q ( {r}^{i + 1} , {e}^{i} ) \qquad ( 19 )$$

In some examples, given the casually consistent vehicle trajectory predictions, only two terms may change in the policy planning algorithm. First, one or more (e.g., all) nodes of the scenario tree may depend on one of the nodes of the trajectory tree of the same stage and are denoted as eⁱ(rⁱ) to emphasize the dependence. As such, it is noted that the dependence may be on rⁱ instead of the entire vehicle trajectory due to the casual consistency. Second, the branching probability may now depend on the trajectory tree node, which is denoted as [symbol] [eⱼⁱ⁺¹|eⁱ(rⁱ)rⁱ]. As such, the value function may be defined by:

$$V ( {r}^{i} , {e}^{i} ( {r}^{i} ) ) = {𝔼}_{{e}^{1 : N}} [ {\sum }_{k = 1}^{N} {L}_{k} ( {r}^{k} , {e}^{k} ( {r}^{k} ) ) ] \qquad ( 20 )$$

Similarly, the Q function may now include:

$$\begin{matrix}Q ( {r}^{i + 1} , {e}^{i} ( {r}^{i} ) ) : = {L}_{i} ( {r}^{i} , {e}^{i} ( {r}^{i} ) ) + {𝔼}_{{e}^{i + 1}} [ V ( {r}^{i + 1} , {e}^{i + 1} ( {r}^{i + 1} ) ) \vert {e}^{i} ( {r}^{i} ) ] \\ = {L}_{i} ( {r}^{i} , {e}^{i} ( {r}^{i} ) ) + \\ {\sum }_{{e}_{j}^{i + 1} ∈ Ch ( {e}^{i} ( {r}^{i} ) , {r}^{i + 1} )} ℙ [ {e}_{j}^{i + 1} \vert {e}^{i} ( {r}^{i} ) , {r}^{i} ] V ( {r}^{i + 1} , {e}_{j}^{i + 1} )\end{matrix} \qquad ( 21 )$$

In equation (21), Ch(eⁱ(rⁱ),rⁱ⁻¹) denotes the set of children nodes following eⁱ(rⁱ) on the tree associated with rⁱ⁺¹. As such, the optimal policy may be defined as:

$${π}^{*} ( {r}^{i} , {e}^{i} ( {r}^{i} ) ) = {arg min}_{∈ {r}^{i + l} Ch ( {r}^{i} )} Q ( {r}^{i + 1} , {e}^{i} ( {r}^{i} ) ) \qquad ( 22 )$$

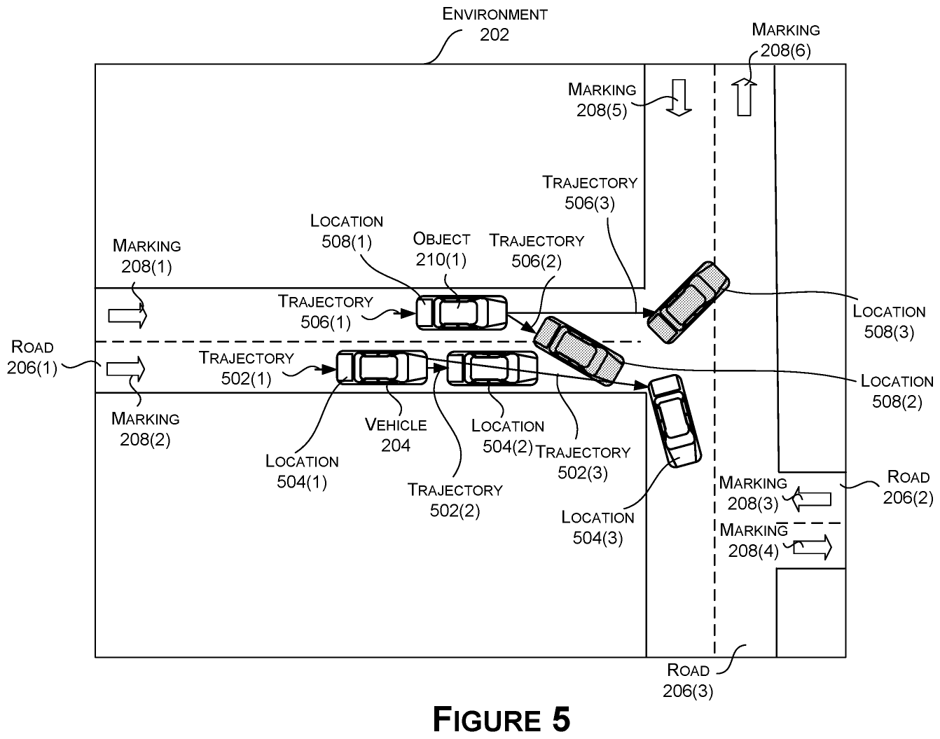

For instance, FIG. 5 illustrates an example of the vehicle 204 performing a policy associated with navigating within the environment 202, in accordance with some embodiments of the present disclosure. In the example of FIG. 5, the second object 210(2) and the third object 210(3) have been removed for clarity reasons.

As shown, a first stage of the policy may cause the vehicle 204 to navigate along a first trajectory 502(1) to a first location 504(1) within the environment 202 based on the first object 210(1) navigating along a first trajectory 506(1) to a first location 508(1) within the environment 202. The policy may then indicate, for a second stage, that if the first object 210(1) navigates along a second trajectory 506(2) and to a second location 508(2) within the environment 202, the vehicle 204 should navigate along a second trajectory 502(2) to a second location 504(2) within the environment. The second stage of the policy may indicate this since the vehicle 204 may collide with the first object 210(1) if the first object 210(1) navigates passed the second location 504(2). However, the policy may further indicate, for the second stage, that if the first object 210(1) navigates along a third trajectory 506(3) and to a third location 508(3) within the environment 202, the vehicle 204 should navigate along a third trajectory 502(3) and to a third location 504(3) within the environment 202. The second stage of the policy may indicate this since the vehicle 204 will not collide with the first object 210(1) if the first object navigates the third trajectory 506(3) and the vehicle 204 navigates the third trajectory 502(3).

Referring back to the example of FIG. 1A, in some examples, the process 100 may continue to repeat at given time intervals such that new policies are determined for the vehicle as the vehicle continues to navigate along an environment. As described herein, a given time interval may include, such is not limited to, 0.1 seconds, 0.2 seconds, 0.5 seconds, 1 second, and/or any other time interval. In some examples, the given time interval for determining a new policy may occur within one or more of the time intervals associated with one or more of the stages of the current policy that is being implemented. For example, while the vehicle is navigating according to a first stage of a current policy, the process 100 may repeat such that a new policy for navigating the vehicle is determined. The vehicle may then start to implement the new policy during the first stage and/or after the first stage is complete.

FIG. 1B is a data flow diagram illustrating a process 124 for training one or more machine learning models 126 to perform policy planning using behavior models, in accordance with some embodiments of the present disclosure. The machine learning model(s) 126 may be associated with the trajectory component 112, the prediction component 116, and/or the programming component 120. For example, the machine learning model(s) 126 may be used to perform one or more of the processes with respect to the trajectory component 112, the prediction component 116, and/or the programming component 120 As shown, the machine learning model(s) 126 may be trained using environmental data 128 and/or history data 130. In some examples, the environmental data 128 may be similar to, and/or include, the environmental data 108. Additionally, in some examples, the history data 110 may be similar to, and/or include, the history data 110.

As shown, the machine learning model(s) 126 may be trained using the training environmental data 128, the training history data 130, and corresponding ground truth data 132. The ground truth data 132 may represent trajectory data 134 representing one or more behavior models indicating candidate trajectories for one or more vehicles, scenario data 136 representing one or more behavior models indicating candidate behaviors associated with one or more objects, and/or policy data representing one or more polices for the vehicle(s). The ground truth data 132 may be generated using a program suitable for generating the ground truth data 132, and/or may be human generated (e.g., by hand), in some examples. In any example, the ground truth data 132 may be synthetically produced (e.g., generated from computer models or renderings), real produced (e.g., designed and produced from real-world data), machine-automated, human annotated (e.g., labeler, or annotation expert, etc.), and/or a combination thereof. In some examples, for each instance of the environmental data 128 and/or the history data 130, there may be corresponding ground truth data 132.

A training engine 140 may use one or more loss functions that measure loss (e.g., error) in outputs 142 as compared to the ground truth data 132. Any type of loss function may be used, such as cross entropy loss, mean squared error, mean absolute error, mean bias error, and/or other loss function types. In some examples, different outputs 142 may have different loss functions. For example, an output 142 associated with behavior models indicating candidate trajectories may have one or more first loss functions, an output 142 associated with candidate behaviors may have one or more second loss functions, and an output 142 associated with polices may have one or more third loss functions. In some examples, backward pass computations may be performed to recursively compute gradients of the loss function(s) with respect to training parameters. In some examples, weights and biases of the machine learning model(s) 126 may be used to compute these gradients. The machine learning model(s) may be trained using supervised learning, semi-supervised learning, and/or unsupervised learning, depending on the particular model and/or the particular embodiment.

In some examples, the training of the machine learning model(s) 126 may include training the machine learning model(s) 126 to generate the trees that includes multiple stages. For example, the training may improve how the machine learning model(s) 126 determines the information (e.g., the candidate trajectories, the candidate behaviors, etc.) for one or more (e.g., each) of the stages, determines how to combine the information for the stages (e.g., determines how to relate the child nodes with the parent nodes), and/to determines one or more additional and/or alternative processes associated with generating the behavior models described herein.

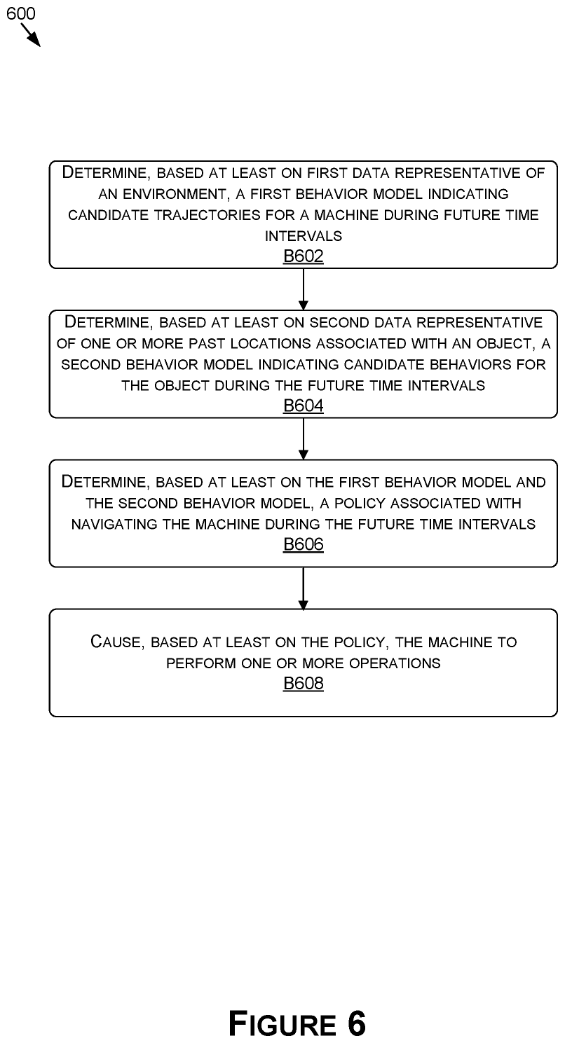

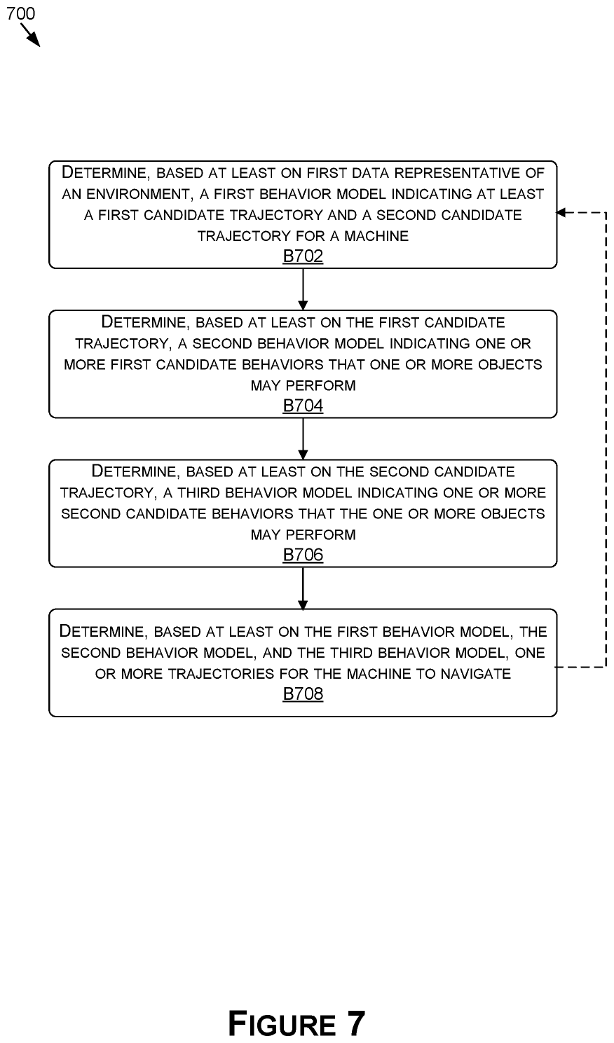

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods 600 and 700 may also be embodied as computer-usable instructions stored on computer storage media. The methods 600 and 700 may be provided by a standalone application, a service or hosted service (standalone or in combination with another hosted service), or a plug-in to another product, to name a few. In addition, the methods 600 and 700 are described, by way of example, with respect to FIG. 1A. However, these methods 600 and 700 may additionally or alternatively be executed by any one system, or any combination of systems, including, but not limited to, those described herein.

FIG. 6 is a flow diagram showing a first method 600 for determining, using behavior models, a policy for navigating a machine, in accordance with some embodiments of the present disclosure. The method 600, at block B602, may include determining, based at least on first data representative of an environment, a first behavior model indicating candidate trajectories for a machine during future time intervals. For instance, the trajectory component 112 may generate, using at least on the environmental data 108 representing the environment, the trajectory data 114 representing the first behavior model (e.g., a trajectory tree). As described herein, the first behavior model may indicate one or more respective candidate trajectories that the machine may navigate during the future time intervals. In some examples, the trajectory component 112 may further generate the trajectory data 114 using additional data, such as the history data 110 representing one or more past locations and/or a current location associated with the machine.

The method 600, at block B604, may include determining, based at least on second data representative of one or more past locations associated with an object, a second behavior model indicating candidate behaviors for the object during the future time intervals. For instance, the prediction component 116 may generate, using at least the history data 110 representing the past location(s) and/or the current location of the object, the scenario data 118 representing the second behavior model (e.g., a scenario tree). As described herein, the second behavior model may indicate one or more respective candidate behaviors that the object may perform during the future time intervals. In some examples, the prediction component 116 may generate the scenario data 118 using additional data, such as the environmental data 108 and/or the trajectory data 114. Additionally, in some examples, the prediction component 116 may generate multiple second behavior models.

The method 600, at block B606, may include determining, based at least on the first behavior model and the second behavior model, a policy associated with navigating the machine during the future time intervals. For instance, the programming component 120 may generate, based at least on the trajectory data 114 and the scenario data 118, the policy data 122 representing the policy for navigating the machine within the environment. For instance, and as described herein, the policy may allow for multistage reasoning that leverages the future reactive behaviors of the object. For example, at one or more stages associated with the policy, the policy may indicate to travel a first trajectory when the object performs a first behavior or travel a second trajectory when the object performs a second behavior.

The method 600, at block B608, may include causing, based at least on the policy, the machine to perform one or more operations. For instance, the machine may use the policy to navigate within the environment. For example, the machine may determine to navigate according to a trajectory associated with a first stage of the policy based on the object performing a specific behavior. In some examples, and as indicated by the dashed line, the method 600 may then repeat as the machine is navigating according to the policy, such as while the machine is navigating according to the trajectory associated with the first stage, to determine a new policy for the machine to perform.

FIG. 7 is a flow diagram showing a second method 700 for determining, using behavior models, a policy for navigating a machine, in accordance with some embodiments of the present disclosure. The method 700, at block B702, may include determining, based at least on first data representative of an environment, a first behavior model indicating at least a first candidate trajectory and a second candidate trajectory for a machine. For instance, the trajectory component 112 may generate, using at least on the environmental data 108 representing the environment, the trajectory data 114 representing the first behavior model. As described herein, the first behavior model may include a trajectory tree that includes branches representing different candidate trajectories that the machine may perform. In some examples, the trajectory component 112 may further generate the trajectory data 114 using additional data, such as the history data 110 representing one or more past locations and/or a current location associated with the machine.

The method 700, at block B704, may include determining, based at least on the first candidate trajectory, a second behavior model indicating one or more first behaviors that one or more objects may perform. For instance, the prediction component 116 may generate, using at least the first candidate trajectory, first scenario data 118 representing the second behavior model. As described herein, the second behavior model may include a first scenario tree indicating the first candidate behavior(s) that the object(s) may perform. In some examples, the prediction component 116 may generate the first scenario data 118 using additional data, such as the environmental data 108 and/or the history data 110.

The method 700, at block B706, may include determining, based at least on the second candidate trajectory, a third behavior model indicating one or more second behaviors that the one or more objects may perform. For instance, the prediction component 116 may generate, using at least the second candidate trajectory, second scenario data 118 representing the third behavior model. As described herein, the third behavior model may include a second scenario tree indicating the second candidate behavior(s) that the object(s) may perform. In some examples, the prediction component 116 may generate the second scenario data 118 using additional data, such as the environmental data 108 and/or the history data 110.

The method 700, at block B708, may include determining, based at least on the first behavior model, the second behavior model, and the third behavior model, one or more trajectories for the machine to navigate. For instance, the programming component 120 may determine, based at least on the trajectory data 114, the first scenario data 118, and the second scenario data 118, the one or more trajectories for the machine to navigate. As described herein, in some examples, the programming component 120 determines a policy indicating the one or more trajectories.

### EXAMPLE AUTONOMOUS VEHICLE

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LiDAR sensor(s) 864, inertial measurement unit (IMU) sensor(s) 866 (e.g., accelerometer(s), gyro scope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UNITS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LiDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LiDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LiDAR sensor(s) 864. The LiDAR sensor(s) 864 may be used for object and pedestrian detection, emergency braking, collision avoidance, and/or other functions. The LiDAR sensor(s) 864 may be functional safety level ASIL B. In some examples, the vehicle 800 may include multiple LiDAR sensors 864 (e.g., two, four, six, etc.) that may use Ethernet (e.g., to provide data to a Gigabit Ethernet switch).

In some examples, the LiDAR sensor(s) 864 may be capable of providing a list of objects and their distances for a 360-degree field of view. Commercially available LiDAR sensor(s) 864 may have an advertised range of approximately 800 m, with an accuracy of 2 cm-3 cm, and with support for a 800 Mbps Ethernet connection, for example. In some examples, one or more non-protruding LiDAR sensors 864 may be used. In such examples, the LiDAR sensor(s) 864 may be implemented as a small device that may be embedded into the front, rear, sides, and/or corners of the vehicle 800. The LiDAR sensor(s) 864, in such examples, may provide up to a 120-degree horizontal and 35-degree vertical field-of-view, with a 200 m range even for low-reflectivity objects. Front-mounted LiDAR sensor(s) 864 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 800. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LiDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVS witch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE COMPUTING DEVICE

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVS witch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### EXAMPLE DATA CENTER

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, based at least on first data representative of an environment, a trajectory tree indicating one or more first candidate trajectories for a machine during a first future period of time and one or more second candidate trajectories for the machine during a second future period of time;
determining, based at least on second data representative of one or more past locations of an object, a scenario tree indicating one or more first possible behaviors for the object during the first future period of time and one or more second possible behaviors for the object during the second future period of time;
determining, based at least on the trajectory tree and the scenario tree, a policy associated with navigating the machine during the first future period of time and the second future period of time; and
causing, based at least on the policy, the machine to perform one or more operations.

2. The method of claim 1, wherein the determining the scenario tree is further based at least on the trajectory tree.

3. The method of claim 1, wherein:
the trajectory tree indicates at least a first candidate trajectory that includes a second candidate trajectory from the one or more first candidate trajectories and a third candidate trajectory from the one or more second candidate trajectories and a fourth candidate trajectory that includes the second candidate trajectory and a fifth candidate trajectory from the one or more second candidate trajectories;
the determining the scenario tree is further based at least on the first candidate trajectory;
the method further comprises determining, based at least on the second data and the fourth candidate trajectory, a second scenario tree indicating one or more third possible behaviors for the object during the first future period of time and one or more fourth possible behaviors for the object during the second future period of time; and
the determining the policy is further based at least on the second scenario tree.

4. The method of claim 1, wherein the trajectory tree indicates that:
a first candidate trajectory of the one or more first candidate trajectories starts at a first location and ends at a second location during the first future period of time; and
a second candidate trajectory of the one or more second candidate trajectories starts at the second location and ends at a third location during the second future period of time.

5. The method of claim 1, wherein the scenario tree indicates that:
a first behavior of the one or more first behaviors starts at a first location and ends at a second location during the first future period of time; and
a second behavior of the one or more second behaviors starts at the second location and ends at a third location during the second future period of time.

6. The method of claim 1, wherein the policy associated with navigating the machine during the first future period of time and the second future period of time indicates:
navigating the machine according to a first candidate trajectory of the one or more first candidate trajectories during the first future period of time; and
one of:
navigating, based at least on the object performing a first behavior of the one or more second behaviors, the machine according to a second candidate trajectory of the one or more second candidate trajectories during the second future period of time; or
navigating, based at least on the object performing a second behavior of the one or more second behaviors, the machine according to a third candidate trajectory of the one or more second candidate trajectories during the second future period of time.

7. The method of claim 1, wherein:
the determining the trajectory tree is further based at least on third data representative of one or more past locations and a current location associated with the machine; and
the determining the scenario tree is further based at least on the first data representative of the environment.

8. The method of claim 1, wherein, during the first future period of time, the method further comprises:
determining, based at least on third data representative of the environment, a second trajectory tree indicating one or more third candidate trajectories for the machine during a third future period of time and one or more fourth candidate trajectories for the machine during a fourth future period of time;
determining, based at least on fourth data representative of one or more second past locations of the object, a second scenario tree indicating one or more third possible behaviors for the object during the third future period of time and one or more fourth possible behaviors for the object during the fourth future period of time;
determining, based at least on the second trajectory tree and the second scenario tree, a second policy associated with navigating the machine during the third future period of time and the fourth future period of time; and
causing, based at least on the second policy, the machine to perform one or more second operations.

9. A system comprising:
one or more processing units to:
determine, based at least on first data representative of an environment, a first output indicating one or more first future trajectories for a machine and one or more second future trajectories for the machine that depend on the one or more first future trajectories;
determine, based at least on second data associated with an object, a second output indicating one or more first future behaviors for the object and one or more second future behaviors for the object that depend on the one or more first future behaviors;
determine, based at least on the first output and the second output, a policy associated with navigating the machine; and
cause the machine to perform one or more operations based at least on the policy.

10. The system of claim 9, wherein the second output is further determined based at least on the first output.

11. The system of claim 9, wherein:
the first output indicates at least a first future candidate trajectory that includes a second future candidate trajectory from the one or more first future candidate trajectories and a third future candidate trajectory from the one or more second future candidate trajectories and a fourth future candidate trajectory that includes the second future candidate trajectory and a fifth future candidate trajectory from the one or more second future candidate trajectories;
the second data is further determined based at least on the first future candidate trajectory;
the one or more processing units are further to determine, based at least on the second data and the fourth future candidate trajectory, a third output indicating one or more third future behaviors for the object and one or more fourth future behaviors for the object that depend on the one or more third future behaviors; and
the policy is further determined based at least on the third output.

12. The system of claim 9, wherein the first output indicates that:
a first future candidate trajectory of the one or more first future candidate trajectories starts at a first location and ends at a second location; and
a second future candidate trajectory of the one or more second future candidate trajectories starts at the second location and ends at a third location.

13. The system of claim 9, wherein the second output indicates that:
a first future behavior of the one or more first future behaviors starts at a first location and ends at a second location; and
a second future behavior of the one or more second future behaviors starts at the second location and ends at a third location.

14. The system of claim 9, wherein the policy associated with navigating the machine indicates:
navigating the machine according to a first future candidate trajectory of the one or more first future candidate trajectories; and
one of:
navigating, based at least on the object performing a first future behavior of the one or more second future behaviors, the machine according to a second future candidate trajectory of the one or more second future candidate trajectories; or
navigating, based at least on the object performing a second future behavior of the one or more second future behaviors, the machine according to a third future candidate trajectory of the one or more second future candidate trajectories.

15. The system of claim 9, wherein:
the first output is further determined based at least on third data representative of one or more past locations and a current location associated with the machine; and
the second output is further determined based at least on the first data representative of the environment.

16. The system of claim 9, wherein the policy is associated with a first period of time, and wherein, during the first period of time, the one or more processing units are further to:
determine, based at least on second data representative of the environment, a third output indicating one or more third future trajectories for the vehicle and one or more fourth future trajectories for the vehicle that depend on the one or more third future trajectories;
determine, based at least on fourth data associated with the object, a fourth output indicating one or more third future behaviors for the object and one or more fourth future behaviors for the object that depend on the one or more third future behaviors;
determine, based at least on the third output and the fourth output, a second policy associated with navigating the machine; and
cause the machine to perform one or more second operations based at least on the second policy.

17. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implementing one or more large language models (LLMs);
a system implemented using an edge device;
a system implemented using a machine;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to cause a machine to perform one or more operations based at least on a policy associated with navigating the machine, wherein the policy is determined based at least on first data representative of candidate trajectories associated with the machine at future time intervals and second data representative of candidate behaviors for one or more objects at the future time intervals.

19. The processor of claim 18, wherein the one or more processing units are further to:
generate the first data based at least on third data representative of an environment and fourth data representative of one or more previous locations associated with the machine; and
generate the second data based at least on the third data, fifth data representative of one or more previous locations associated with the one or more objects, and the first data.

20. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implementing one or more large language models (LLMs);
a system implemented using an edge device;
a system implemented using a machine;
a system for performing conversational AI operations;
a system for generating synthetic data;
a system incorporating one or more virtual machines (VMs);
a system implemented at least partially in a data center; or
a system implemented at least partially using cloud computing resources.
